(19) United States
(12) Patent Application Publication
(10) Pub. No.: US 2016/0064025 A1
(43) Pub. Date: Mar. 3, 2016

(54) MAGNETIC RECORDING MEDIUM

(71) Applicant: FUJIFILM CORPORATION, Tokyo (JP)

(72) Inventors: Takuto KUROKAWA, Minami-ashigara-shi (JP); Kazutoshi KATAYAMA, Minami-ashigara-shi (JP)

(73) Assignee: FUJIFILM CORPORATION, Tokyo (JP)

(21) Appl. No.: 14/838,663

(22) Filed: Aug. 28, 2015

(30) Foreign Application Priority Data
Aug. 29, 2014 (JP) 2014-176593

(51) Int. Cl. G11B 5/71

(52) U.S. Cl. CPC G11B 5/71

(57) ABSTRACT

The magnetic recording medium comprises a nonmagnetic layer comprising nonmagnetic powder and binder on a nonmagnetic support and a magnetic layer comprising ferromagnetic powder and binder on the nonmagnetic layer, wherein the magnetic layer comprises a lubricant and a 1-bromonaphthalene contact angle adjusting agent that is capable of adjusting a contact angle for 1-bromonaphthalene, the contact angle for 1-bromonaphthalene being measured on a surface of the magnetic layer, and the contact angle measured on the surface of the magnetic layer ranges from 45.0° to 55.0° for 1-bromonaphthalene, and ranges from 90.0° to 100.0° for water.

### CROSS-REFERENCE TO RELATED APPLICATIONS

This application claims priority under 35 U.S.C 119 to Japanese Patent Application No. 2014-176593 filed on Aug. 29, 2014. The above application is hereby expressly incorporated by reference, in its entirety.

### BACKGROUND OF THE INVENTION

1. Field of the Invention

The present invention relates to a magnetic recording medium.

2. Discussion of the Background

The recording and reproduction of signals on magnetic recording media such as magnetic tapes are normally conducted by running a magnetic recording medium within a drive so that the surface of a magnetic layer contacts (slides against) a magnetic head (also referred to simply as a “head”, hereinafter). In such running, where there is considerable friction during sliding of the surface of the magnetic layer against the head, a portion of the magnetic layer is shaved off, and a phenomenon occurs whereby the shavings that are generated adhere to the surface of the head. When a large amount of such shavings has adhered to the surface of the head, a drop in output (spacing loss) occurs due to the spacing between the surface of the magnetic layer and the head. To maintain high output following repeated running in magnetic recording media, there is a need to prevent large amounts of shavings from being generated when sliding against the head, that is, to achieve good running durability.

With regard to running durability, it has been proposed that the sliding properties between the surface of the magnetic layer and the head during running be stabilized and that running durability be increased by incorporating a lubricant into the magnetic layer and/or the nonmagnetic layer (for example, see Japanese Unexamined Patent Publication (KOKAI) No. 2002-298332, Japanese Unexamined Patent Publication (KOKAI) No. 2012-43495 or English language family member US2012/045664A1, Japanese Unexamined Patent Publication (KOKAI) Heisei No. 2-227821, and Japanese Unexamined Patent Publication (KOKAI) Heisei No. 11-259849 or English language family member EP0520155B1, which are expressly incorporated herein by reference in their entirety).

### SUMMARY OF THE INVENTION

The use of a lubricant as has been done in the past can be an effective way to increase running durability. However, based on investigation conducted by the present inventors, attempting to increase running durability by simply adding a lubricant may cause the spacing loss due to the lubricant to become non-negligible. Examples of such spacing loss are the spacing loss that is caused by a large amount of lubricant being present on the surface of the magnetic layer and lubricant adhering to the head from the surface of the magnetic layer, and the spacing loss that is caused by shavings, generated by shaving during sliding of a magnetic layer that has been plasticized and embrittled by large amounts of lubricant, adhering to the head. Accordingly, there is a need for a new way to increase the running durability of a magnetic recording medium that does not depend solely on lubricant.

An aspect of the present invention provides for a new means of increasing the running durability of a magnetic recording medium.

The present inventors conducted extensive research, resulting in the discovery of the following magnetic recording medium:

A magnetic recording medium, which comprises a nonmagnetic layer comprising nonmagnetic powder and binder on a nonmagnetic support and a magnetic layer comprising ferromagnetic powder and binder on the nonmagnetic layer, wherein

the magnetic layer comprises a lubricant and a 1-bromonaphthalene contact angle adjusting agent that is capable of adjusting a contact angle for 1-bromonaphthalene, the contact angle for 1-bromonaphthalene being measured on a surface of the magnetic layer; and

the contact angle measured on the surface of the magnetic layer ranges from 45.0° to 55.0° for 1-bromonaphthalene, and ranges from 90.0° to 100.0° for water.

An aspect of the present invention was devised on that basis.

The contact angle for 1-bromonaphthalene is also referred to as the “bromonaphthalene contact angle”, hereinafter. The contact angle of water is referred to as the “water contact angle”, hereinafter. The bromonaphthalene contact angle and the water contact angle are evaluated by the liquid drop method. Specifically, the “contact angle” refers to the arithmetic average value of values obtained by conducting six measurements of a sample by the θ/2 method in a measurement environment of 25° C. and 25% relative humidity. An example of a specific embodiment of the measurement conditions will be described further below in Examples.

In one embodiment, the 1-bromonaphthalene contact angle adjusting agent can be a polymer. In this context, the term “polymer” is a polymer comprised of multiple identical or different repeating units, and is used with a meaning that includes both homopolymers and copolymers.

In one embodiment, the 1-bromonaphthalene contact angle adjusting agent can be a nitrogen-containing polymer.

In one embodiment, the 1-bromonaphthalene contact angle adjusting agent can be a polyalkyleneimine polymer.

In one embodiment, the 1-bromonaphthalene contact angle adjusting agent can be a polyalkyleneimine polymer containing one or more polyalkyleneimine chains and one or more polyester chains.

In one embodiment, the 1-bromonaphthalene contact angle adjusting agent can be an amine polymer.

In one embodiment, the magnetic layer can contain one or more lubricants selected from the group consisting of fatty acids, fatty acid esters, and fatty acid amides.

In one embodiment, the thickness of the nonmagnetic layer can be less than or equal to 0.80 μm.

In one embodiment, the nonmagnetic layer can contain a lubricant. The nonmagnetic layer that contains the lubricant can function as a tank for supplying lubricant to the magnetic layer.

In one embodiment, the nonmagnetic layer can contain one or more lubricants selected from the group consisting of fatty acids, fatty acid esters, and fatty acid amides.

In one embodiment, the magnetic layer can contain one or more fatty acids, one or more fatty acid esters, and one or more fatty acid amides.

Generally, the greater the surface smoothness of the magnetic layer, the greater the advantage afforded during high density recording. However, there is a tendency that friction between the surface of the magnetic layer and the head during sliding increases and running durability decreases. Even in such a magnetic recording medium, good running durability can be achieved by controlling the 1-bromonaphthalene contact angle and water contact angle as set forth above.

In this regard, in one embodiment, the centerline average surface roughness Ra as measured by an atomic force microscope on the surface of the magnetic layer can be less than or equal to 3.0 nm.

The centerline average surface roughness Ra as measured by an atomic force microscope refers to the centerline average surface roughness Ra as measured over a region with an area of 40 μm x 40 μm on the surface of the magnetic layer. An example of an atomic force microscope is the NANO SCOPE (Japanese registered trademark) III made by Digital Instruments Corp. employed in contact mode. Reference can be made to the description given in Examples further below for specific examples of measurement conditions.

An aspect of the present invention can provide a magnetic recording medium affording good running durability.

Other exemplary embodiments and advantages of the present invention may be ascertained by reviewing the present disclosure and the accompanying drawing(s).

### BRIEF DESCRIPTION OF THE DRAWINGS

The present invention will be described in the following text by the exemplary, non-limiting embodiments shown in the drawing, wherein:

FIG. 1 is a drawing descriptive of the method of evaluating head fouling (head surface fouling, head edge fouling) in Examples.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

An aspect of the present invention relates to a magnetic recording medium, which comprises a nonmagnetic layer comprising nonmagnetic powder and binder on a nonmagnetic support and a magnetic layer comprising ferromagnetic powder and binder on the nonmagnetic layer, wherein the magnetic layer comprises a lubricant and a 1-bromonaphthalene contact angle adjusting agent (also referred to hereinafter simply as a “contact angle adjusting agent”) that is capable of adjusting a contact angle for 1-bromonaphthalene, the contact angle for 1-bromonaphthalene being measured on a surface of the magnetic layer; and the contact angle measured on the surface of the magnetic layer ranges from 45.0° to 55.0° for 1-bromonaphthalene, and ranges from 90.0° to 100.0° for water.

Although not intended to limit the present invention in any way, the reasons that the above magnetic recording medium can exhibit good running durability are thought by the present inventors to be as follows.

As set forth above, the simple use of a lubricant may end up causing a spacing loss due to the lubricant. With spacing losses that are caused by lubricants in this manner, the nonmagnetic layer, which could function as a lubricant tank, is made thinner and there is a marked tendency to increase the quantity of lubricant that is added to the magnetic layer to make up for the inadequate supply from the thinner nonmagnetic layer.

Accordingly, the present inventors conducted extensive research into ways of increasing running durability other than just increasing the quantity of lubricant added. As a result, the 1-bromonaphthalene contact angle drew their attention. This point will be described in greater detail. The present inventors conducted an investigation based on the theory (three liquid theory) of Kitasaki and Hata of the free surface energy on the surface of the magnetic layer. According to the three liquid theory, free surface energy can be calculated as the sum of the dispersive component, hydrogen bond component, and polarization component. However, in the free surface energy that is measured on the surface of the magnetic layer in a magnetic recording medium, due to the physical properties of the structural components of the magnetic layer, the dispersive component is thought to dominate. Accordingly, the dispersive component is presumed to primarily contribute to affinity between the surface of the magnetic layer and the head. Thus, the present inventors conducted further research into indicators of the dispersive component. As a result, they adopted the 1-bromonaphthalene contact angle. They examined controlling the surface properties of the magnetic layer based on this value. However, although it is possible to increase the 1-bromonaphthalene contact angle by adding lubricant, when controlling the 1-bromonaphthalene contact angle by just adding lubricant, as stated above, a spacing loss may end up being caused by the lubricant. Accordingly, the present inventors adopted the water contact angle as an indicator of the quantity of lubricant present on the surface of the magnetic layer in addition to the 1-bromonaphthalene contact angle. They discovered that it was possible to provide a magnetic recording medium affording good running durability using these two contact angles to effect control. More specifically, they discovered that by using a contact angle adjusting agent that was capable of adjusting the contact angle of 1-bromonaphthalene along with lubricant to control both the 1-bromonaphthalene contact angle and water contact angle, it was possible to inhibit spacing loss due to shavings on the surface of the magnetic layer and spacing loss due to lubricant. An aspect of the present invention was devised on that basis.

However, this is merely conjecture on the part of the present inventors and is not intended to limit the present invention.

The contact angle of methylene iodide that is described in Japanese Unexamined Patent Publication (KOKAI) Heisei No. 11-259849, paragraphs 0101 to 0186, is an example of an indicator of the amount of lubricant present on the surface of the magnetic layer. In the contact angle for methylene iodide, the effect of the polarization component is thought to be present in addition to that of the dispersive component among the three components constituting the free surface energy based on the three liquid method, thus rendering it unsuitable as an indicator of affinity between the head and the surface of the magnetic layer. Japanese Unexamined Patent Publication (KOKAI) Heisei No. 11-259849, which merely discloses such a contact angle for methylene iodide, provides no suggestion for an aspect of the present invention.

The above magnetic recording medium will be described in greater detail.

<1. Magnetic Layer>

### (1-1. 1-Bromonaphthalene Contact Angle and Water Angle Measured on the Surface of the Magnetic Layer)

In the above magnetic recording medium, the 1-bromonaphthalene contact angle that is measured on the surface of the magnetic layer falls within a range of 45.0° to 55.0° and the water contact angle within a range of 90.0° and 100.0°. A magnetic recording medium in which the 1-bromonaphthalene contact angle and water angle measured on the surface of the magnetic layer fall within the above-stated ranges can exhibit good running durability. More specifically, it can exhibit good running durability by preventing the adhesion of shavings from the surface of the magnetic layer surface that cause spacing loss and inhibiting the adhesion of large amounts of adhesive that causes spacing loss to the surface of the head following repeated running. The presumptions of the present inventors with regard to specifying the 1-bromonaphthalene contact angle and water contact angle are as set forth above.

From the perspective of effectively preventing the generation of shavings from the surface of the magnetic layer, the 1-bromonaphthalene contact angle is desirably greater than or equal to 46.0°, preferably greater than or equal to 47.0°. From a similar perspective, the water contact angle is desirably greater than or equal to 93.0°, preferably greater than or equal to 95.0°.

From the perspective of reducing the quantity of lubricant adhering to the head, the 1-bromonaphthalene contact angle is desirably less than or equal to 53.0°, preferably less than or equal to 52.0°. From a similar perspective, the water contact angle is desirably less than or equal to 99.5°, preferably less than or equal to 99.0°.

The 1-bromonaphthalene contact angle and water contact angle described above can be controlled by the use of lubricant and a contact angle adjusting agent that is capable of adjusting the 1-bromonaphthalene contact angle. Specifically, the greater the quantity of contact angle adjusting agent added, the higher the 1-bromonaphthalene contact angle measured on the surface of the magnetic layer tends to be. The greater the quantity of lubricant that is present on the surface of the magnetic layer, the higher the water contact angle tends to be. A more detailed description will be given further below.

(1-2. Lubricant)

Examples of the lubricant that is contained in the magnetic layer are the various lubricants commonly employed in magnetic recording media, such as fatty acids, fatty acid esters, and fatty acid amides.

Examples of fatty acids are lauric acid, myristic acid, palmitic acid, steric acid, oleic acid, linoleic acid, linolenic acid, behenic acid, erucic acid, and elaidic acid. Stearic acid, myristic acid, and palmitic acid are desirable, and stearic acid is preferred. Fatty acids can also be incorporated into the magnetic layer in the form of salts such as metal salts.

Examples of fatty acid esters are esters of each of the above fatty acids, such as butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate.

Examples of fatty acid amides are amides of each of the above fatty acids, such as amide laurate, amide myristate, amide palmitate, and amide stearate.

It is desirable to employ a fatty acid in combination with one or more fatty acid derivative. It is preferable to employ a fatty acid in combination with one or more selected from the group consisting of fatty acid esters and fatty acid amides. And it is of greater preference to employ a fatty acid in combination with a fatty acid ester and a fatty acid amide.

When employing a fatty acid in combination with a fatty acid derivative (ester, amide, or the like), the fatty acid-derived moiety of the fatty acid derivative desirably has the same structure or one similar to that of the fatty acid with which it is being employed. As an example, when employing stearic acid as a fatty acid, it is desirable to employ a stearic acid ester or amide stearate.

The lubricant described in Japanese Unexamined Patent Publication (KOKAI) No. 2009-96798, paragraph 0111 can be employed. The content of the above publication is expressly incorporated herein by reference in its entirety

The content of lubricant in the magnetic layer is, for example, 6.0 to 12.0 weight parts, desirably 7.0 to 11.0 weight parts, and preferably 8.0 to 10.0 weight parts, per 100.0 weight parts of ferromagnetic powder. When employing two or more different lubricants as lubricant, the content refers to the combined content thereof. Unless specifically stated otherwise in the present Specification, the same applies to the contents of other components.

(1-3. 1-Bromonaphthalene Contact Angle Adjusting Agent)

A 1-bromonaphthalene contact angle adjusting agent is contained with lubricant in the magnetic layer. The term “1-bromonaphthalene contact angle adjusting agent” is a component that is capable of adjusting the 1-bromonapthalene contract angle that is measured on the surface of the magnetic layer. Here, the term “capable of adjusting” means capable of exhibiting an effect that changes the 1-bromonaphthalene contact angle, desirably exhibiting an effect that increases the 1-bromonaphthalene contact angle. By exhibiting such an effect, it is possible to determine whether the 1-bromonaphthalene contact angle adjusting agent is present by whether or not the 1-bromonaphthalene contact angle that is measured on the surface of the magnetic layer changes. It does not matter whether the 1-bromonaphthalene contact angle adjusting agent changes (raises or lowers) the water contact angle.

One, two, or more contact angle adjusting agents can be employed. From the perspective of facilitating control of the 1-bromonaphthalene contact angle, the content of contact angle adjusting agent in the magnetic layer is desirably greater than or equal to 0.5 weight part, preferably greater than or equal to 1.0 weight part, per 100.0 weight parts of ferromagnetic powder. Additionally, from the perspective of high density recording, the content of other components is desirably relatively low to increase the fill rate of ferromagnetic powder. From this perspective, the content of contact angle adjusting agent in the magnetic layer is desirably less than or equal to 50.0 weight parts, preferably less than or equal to 40.0 weight parts, more preferably less than or equal to 30.0 weight parts, still more preferably less than or equal to 20.0 weight parts, and even more preferably, less than or equal to 15.0 weight parts, per 100 weight parts of ferromagnetic powder.

The contact angle adjusting agent is desirably in the form of a compound having a structure containing a hydrophobic moiety thought to contribute to increase the 1-bromonaphthalene contact angle and a moiety that adsorbs to the surface of the ferromagnetic powder.

In one embodiment, the contact angel adjusting agent is desirably a polymer. The present inventors presume that the polymer chain contained in the polymer can contribute to increasing the 1-bromonaphthalene contact angle that is measured on the surface of the magnetic layer. From the perspective of increasing the 1-bromonaphthalene contact angle, the polymer chain is preferably a hydrophobic chain. Specific examples of desirable polymer chains will be given further below.

In one embodiment, the polymer is desirably a nitrogen-containing polymer. The term “nitrogen-containing polymer” means a polymer that contains nitrogen atom(s) in the structure thereof. Examples of desirable nitrogen-containing polymers are polyalkyleneimine polymers and amine polymers.

In one embodiment, the polymer is desirably a polymer with a weight average molecular weight falling within a range that does not exceed the weight average molecular weight of the binder contained in the magnetic layer.

Desirable polyalkyleneimine polymers will be described below.

(1-3-1. Polyalkyleneimine Polymer)

(1-3-1-a. Polyalkyleneimine Chain)

The term “polyalkyleneimine polymer” refers to a polymer containing one or more polyalkyleneimine chains. The term “polyalkyleneimine chain” refers to a polymerization structure comprising two or more identical or different alkyleneimine chains. Examples of the alkyleneimine chains that are contained are the alkyleneimine chain denoted by formula A below and the alkyleneimine chain denoted by formula B below. Among the alkyleneimine chains denoted by the formulas given below, the alkyleneimine chain denoted by formula A can contain a bond position with another polymer chain. The alkyleneimine chain denoted by formula B can be bonded by means of a salt crosslinking group (described in greater detail further below) to another polymer chain. The polyalkyleneimine chain can have only a linear structure, or can have a branched tertiary amine structure. Examples comprising branched structures are ones where the alkyleneimine chain is bonded to an adjacent alkyleneimine chain at *¹ in formula A below and where it is bonded to the adjacent alkyleneimine chain at *² in formula B below.

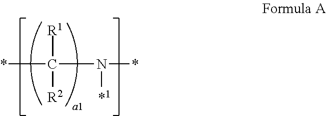

In formula A, each of R¹ and R² independently denotes a hydrogen atom or an alkyl group; a1 denotes an integer of equal to or greater than 2; and *¹ denotes the site of a bond with an adjacent another polymer chain (such as a polyester chain, an adjacent alkyleneimine chain set forth below), or a hydrogen atom or a substituent.

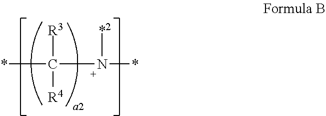

In formula B, each of R³ and R⁴ independently denotes a hydrogen atom or an alkyl group, and a2 denotes an integer of equal to or greater than 2. The alkyleneimine chain denoted by formula B bonds to another polymer chain having an anionic group by N⁺ in formula B and the anionic group contained in another polymer chain forming a salt crosslinking group.

The * in formulas A and B, and the *² in formula B, each independently denotes the position of a bond with an adjacent alkyleneimine chain, a hydrogen atom or a substituent.

Formulas A and B will be described in greater detail below. In the present invention, unless specifically stated otherwise, the groups that are described can be substituted or unsubstituted. When a given group comprises substituent(s), examples of the substituent are alkyl groups (such as alkyl groups having 1 to 6 carbon atoms), hydroxyl groups, alkoxy groups (such as alkoxy groups having 1 to 6 carbon atoms), halogen atoms (such as fluorine atoms, chlorine atoms, and bromine atoms), cyano groups, amino groups, nitro groups, acyl groups, and carboxyl groups. For a group having a substituent, the “number of carbon atoms” means the number of carbon atoms of the portion not comprising the substituent.

Each of R¹ and R² in formula A, and each of R³ and R⁴ in formula B, independently denotes a hydrogen atom or an alkyl group. Examples of the alkyl groups are alkyl groups having 1 to 6 carbon atoms, desirably alkyl groups having 1 to 3 carbon atoms, preferably methyl or ethyl groups, and more preferably, methyl groups. Combinations of R¹ and R² in formula A include an embodiment where one denotes a hydrogen atom and the other denotes an alkyl group, an embodiment where both denote alkyl groups (identical or different alkyl groups), and desirably, an embodiment where both denote hydrogen atoms. The above matters are also applied to R³ and R⁴ in formula B.

The structure with the fewest carbon atoms constituting the ring in an alkyleneimine is ethyleneimine. The number of carbon atoms on the main chain of the alkyleneimine chain (ethyleneimine chain) obtained by opening the ring of ethyleneimine is 2. Accordingly, the lower limit of a1 in formula A and of a2 in formula B is 2. That is, each of a1 in formula A and a2 in formula B independently denotes an integer of equal to or greater than 2. From the perspective of adsorption to the surface of particles of ferromagnetic powder, each of a1 in formula A and a2 in formula B is independently desirably equal to or less than 10, preferably equal to or less than 6, more preferably equal to or less than 4, still more preferably 2 or 3, and yet still more preferably, 2.

The bond between the alkyleneimine chain denoted by formula A or the alkyleneimine chain denoted by formula B and another polymer chain will be described further below.

Each of the alkyleneimine chains set forth above bonds to an adjacent alkyleneimine chain, a hydrogen atom, or a substituent at the positions denoted by * in the various formulas above. An example of a substituent is a monovalent substituent such as an alkyl group (such as an alkyl group with 1 to 6 carbon atoms), but this is not a limitation. Another polymer chain (such as a polyester chain set forth below) can also be bonded as a substituent.

With regard to the polyalkyleneimine polymer, the present inventors presume that the polyalkyleneimine chain can function as an adsorbing moiety that can adsorb to the surface of the particles of ferromagnetic powder. From the perspective of adsorption to the surface of the particles of ferromagnetic powder, the number average molecular weight of the polyalkyleneimine chain is desirably equal to or higher than 300, and preferably equal to or higher than 500. From the same perspective, it is desirably equal to or lower than 3,000, and preferably equal to or lower than 2,000.

In the present invention, the number average molecular weight of the polyalkyleneimine chain contained in the polyalkyleneimine polymer refers to a value, obtained by gel permeation chromatography (GPC) using standard polystyrene conversion, for the polyalkyleneimine obtained by hydrolyzing the polyalkyleneimine polymer. The value thus obtained is the same as or similar to the value obtained by gel permeation chromatography (GPC) using standard polystyrene conversion for the polyalkyleneimine used to synthesize the polyalkyleneimine polymer. Accordingly, the number average molecular weight obtained for the polyalkyleneimine used to synthesize the polyalkyleneimine polymer can be adopted as the number average molecular weight of the polyalkyleneimine chain contained in the polyalkyleneimine polymer. Reference can be made to Examples set forth further below for the conditions for measuring the number average molecular weight of the polyalkyleneimine chain. Polyalkyleneimine is a polymer that can be obtained by ring-opening polymerization of alkyleneimine.

Further, hydrolysis of the polyalkyleneimine polymer can be conducted by any of the various methods commonly employed as ester hydrolysis methods. For details regarding such methods, for example, reference can be to the description of hydrolysis methods given in “Experimental Chemistry Lecture 14 Synthesis of Organic Compounds II—Alcohols.Amines (5th Ed.),” (compiled by the Chemical Society of Japan, Maruzen Publishing, released August 2005), pp. 95 to 98; and to the description of hydrolysis methods given in “Experimental Chemistry Lecture 16 Synthesis of Organic Compounds IV—Carboxylic Acids. Amino Acids.Peptides (5th Ed.),” (compiled by the Chemical Society of Japan, Maruzen Publishing, released March 2005), pp. 10 to 15, which are expressly incorporated herein by reference in their entirety.

Polyalkyleneimine can be separated from the hydrolysis product thus obtained by known separation means such as liquid chromatography, and the number average molecular weight thereof can be obtained.

From the perspective of facilitating control of the 1-bromonaphthalene contact angle, the proportion accounted for by polyalkyleneimine chains in the polyalkyleneimine polymer (also referred to as the “polyalkyleneimine chain ratio”, hereinafter) is desirably less than 5.0 weight percent, preferably less than or equal to 4.9 weight percent, more preferably less than or equal to 4.8 weight percent, still more preferably less than or equal to 4.5 weight percent, yet more preferably less than or equal to 4.0 weight percent, and even more preferably, less than or equal to 3.0 weight percent. From the same perspective, the polyalkyleneimine chain ratio is desirably greater than or equal to 0.2 weight percent, preferably greater than or equal to 0.3 weight percent, and more preferably, greater than or equal to 0.5 weight percent.

The above proportion accounted for by polyalkyleneimine chains can be controlled, for example, by means of the mixing ratio of polyalkyleneimine and polyester employed during synthesis.

The proportion in the polyalkyleneimine polymer accounted for by the polyalkyleneimine chain can be calculated from the results of analysis by nuclear magnetic resonance (NMR)—more specifically, ¹H-NMR and ¹³C-NMR—and by elemental analysis by known methods. Since the value thus calculated is identical to or similar to the theoretical value obtained from the compounding ratio of the synthesis starting materials of the polyalkyleneimine polymer, the theoretical value obtained from the compounding ratio can be adopted as the proportion in the polyalkyleneimine polymer accounted for by the polyalkyleneimine chain (polyalkyleneimine chain ratio).

(1-3-1-b. Polyester Chain)

In addition to the polyalkyleneimine chain set forth above, the polyalkyleneimine polymer desirably comprises another polymer chain(s). A desirable example of another polymer chain is one that is capable of functioning as a hydrophobic moiety (hydrophobic chain). The hydrophobic chain is desirably a polyester chain. In one embodiment, the alkyleneimine chain denoted by formula A and a polyester chain can form —N—(C═O)— by bonding of the nitrogen atom N in formula A to a carbonyl group —(C═O)— at *¹ in formula A. In another embodiment, the alkyleneimine chain denoted by formula B and a polyester chain can form a salt crosslinking group by means of the nitrogen cation N⁺ in formula B and the anionic group present in a polyester chain. An example of a salt crosslinking group is one formed from the oxygen anion O⁻ contained in a polyester chain and the N⁺ contained in formula B. However, this is not intended as a limitation.

The polyester chain denoted by formula 1 below is an example of a polyester chain bonding to the nitrogen atom N contained in formula A by means of a carbonyl bond —(C═O)— to the alkyleneimine chain denoted by formula A. The polyester chain denoted by formula 1 below can bond to the alkyleneimine chain denoted by formula A at the bond position denoted by *¹ by the formation of —N—(C═O)— by the nitrogen atom contained in the alkyleneimine chain and the carbonyl group —(C═O)— contained in the polyester chain.

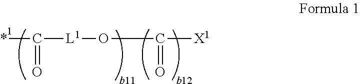

The polyester chain denoted by formula 2 below is an example of a polyester chain that can bond to the alkyleneimine chain denoted by formula B by means of the N⁺ in formula B and an anionic group contained in the polyester chain forming a salt crosslinking group. In the polyester group denoted by formula 2 below, the oxygen anion O⁻ and the N⁺ in formula B can form a salt crosslinking group.

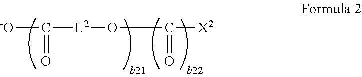

Each of L¹ in formula 1 and L² in formula 2 independently denotes a divalent linking group. A desirable example of a divalent linking group is an alkylene group having 3 to 30 carbon atoms. As set forth above, the number of carbon atoms in an alkylene group refers to the portion (main chain portion) excluding the substituent when the alkylene group comprises a substituent.

Each of b11 in formula 1 and b21 in formula 2 independently denotes an integer of equal to or greater than 2; for example, an integer of equal to or less than 200. The number of repeating lactone units given in Examples further below corresponds to b11 in formula 1 or b21 in formula 2.

Each of b12 in formula 1 and b22 in formula 2 independently denotes 0 or 1.

Each of X¹ in formula 1 and X² in formula 2 independently denotes a hydrogen atom or a monovalent substituent. Examples of monovalent substituents are monovalent substituents selected from the group consisting of alkyl groups, haloalkyl groups (such as fluoroalkyl groups), alkoxy groups, polyalkyleneoxyalkyl groups, and aryl groups.

The alkyl group may be substituted or unsubstituted. An alkyl group substituted with at least one hydroxyl group (a hydroxyalkyl group) and an alkyl group substituted with at least one halogen atom are desirable as a substituted alkyl group. An alkyl group in which all the hydrogen atoms bonded to carbon atoms have been substituted with halogen atoms (a haloalkyl group) is also desirable. Examples of halogen atoms include fluorine, chlorine and bromine atoms. An alkyl group having 1 to 30 carbon atoms is preferred, and an alkyl group having 1 to 10 carbon atoms is of greater preference. The alkyl group can be linear, have a branched chain, or be cyclic. The same applies to a haloalkyl group.

Specific examples of substituted and unsubstituted alkyl groups and haloalkyl groups are: a methyl group, ethyl group, propyl group, butyl group, pentyl group, hexyl group, heptyl group, octyl group, nonyl group, decyl group, undecyl group, dodecyl group, tridecyl group, pentadecyl group, hexadecyl group, heptadecyl group, octadecyl group, eicosyl group, isopropyl group, isobutyl group, isopentyl group, 2-ethylhexyl group, tert-octyl group, 2-hexyldecyl group, cyclohexyl group, cyclopentyl group, cyclohexylmethyl group, octylcyclohexyl group, 2-norbornyl group, 2,2,4-trimethylpentyl group, acetylmethyl group, acetylethyl group, hydroxymethyl group, hydroxyethyl group, hydroxylpropyl group, hydroxybutyl group, hydroxypentyl group, hydroxyhexyl group, hydroxyheptyl group, hydroxyoctyl group, hydroxynonyl group, hydroxydecyl group, chloromethyl group, dichloromethyl group, trichloromethyl group, bromomethyl group, 1,1,1,3,3,3-hexafluoroisopropyl group, heptafluoropropyl group, pentadecafluoroheptyl group, nonadecafluorononyl group, hydroxyundecyl group, hydroxydodecyl group, hydroxypentadecyl group, hydroxyheptadecyl group, and hydroxyoctadecyl group.

Examples of alkoxy groups are a methoxy group, ethoxy group, propyloxy group, hexyloxy group, methoxyethoxy group, methoxyethoxyethoxy group, and methoxyethoxyethoxymethyl group.

Polyalkyleneoxyalkyl groups are monovalent substituents denoted by R¹⁰(OR¹¹)n(O)m-. R¹⁰ denotes an alkyl group, R¹¹ denotes an alkylene group, n denotes an integer of equal to or greater than 2, and m denotes 0 or 1.

The alkyl group denoted by R¹⁰ is as described for the alkyl groups denoted by X¹ and X². The details of the alkylene group denoted by R¹¹ are as follows. The above description of the alkyl groups denoted by X¹ and X² can be applied to these alkylene groups by reading alkylenes with one fewer hydrogen atom for the former (for example, by reading “methylene group” for “methyl group”). n denotes an integer of equal to or greater than 2; for example, an integer of equal to or less than 10, desirably equal to or less than 5.

The aryl group can be substituted and can be a condensed ring. It is preferably an aryl group with 6 to 24 carbon atoms, such as a phenyl group, a 4-methylphenyl group, 4-phenylbenzoic acid, a 3-cyanophenyl group, a 2-chlorophenyl group, or a 2-naphthyl group.

The polyester chains denoted by formulas 1 and 2 above can be structures derived from polyesters obtained by known polyester synthesis methods. Lactone ring-opening polymerization is an example of a polyester synthesis method. Examples of lactones are ε-captolactone, δ-caprolactone, β-propiolactone, γ-butyrolactone, δ-valerolactone, γ-valerolactone, enantolactone, β-butyrolactone, γ-hexanolactone, γ-octanolactone, δ-hexanolactone, δ-octanolactone, 6-dodecanolactone, α-methyl-γ-butyrolactone, and lactide. The lactide can be of either the L or D form. In polyester synthesis, it is possible to use one type of lactone, or two types or more of differing structure. ε-lactone, lactides, and δ-valerolactone are desirable as lactones from the perspectives of reactivity and availability. However, there is no limitation thereto. Any lactone yielding polyester by means of ring-opening polymerization will do.

Carboxylic acid, alcohols, and the like can be employed as nucleophilic reagents in lactone ring-opening polymerization. Carboxylic acid is desirable. One type of carboxylic acid or a mixture of two or more types can be employed.

Carboxylic acid can be denoted as R¹²(C═O)OH. The moiety R¹²(C═O)— can be present as the moiety X¹—(C═O)— in the polyester chain denoted by formula 1. The same applies to the moiety X²—(C═O)— on the polyester chain denoted by formula 2.

R¹² can be acyclic in structure (linear or branched in structure), or can be cyclic in structure. The details of R¹² are as set forth for X¹ in formula 1 and X² in formula 2 above.

Examples of carboxylic acids are acetic acid, propionic acid, butyric acid, valeric acid, n-hexanoic acid, n-octanoic acid, n-decanoic acid, n-dodecanoic acid, palmitic acid, 2-ethylhexanoic acid, cyclohexanoic acid, stearic acid, glycolic acid, lactic acid, 3-hydroxypropionic acid, 4-hydroxydodecanoic acid, 5-hydroxydodecanoic acid, cyclohexylacetic acid, adamantanecarboxylic acid, adamantaneacetic acid, ricinoleic acid, 12-hydroxydodecanoic acid, 12-hydroxystearic acid, 2,2-bis(hydroxymethyl)butyric acid, [2-(2-methoxyethoxy)ethoxy)]acetic acid, monochloroacetic acid, dichloroacetic acid, bromoacetic acid, nonafluorovaleric acid, heptadecafluorononanoic acid, 3,5,5-trimethylhexanoic acid, acetyl acetic acid, 4-oxovaleric acid, benzoic acid, 4-phenylbenzoic acid, and 2-naphthoic acid. Among these, carboxylic acids with 1 to 20 total carbon atoms per molecule (including the number of carbon atoms of the substituents when present) are desirable. Carboxylic acids in which R¹² is a polyalkyleneoxyalkyl group (polyalkyleneoxyalkylcarboxylic acids), carboxylic acids in which R¹² is a haloalkyl group (haloalkylcarboxylic acids), linear aliphatic carboxylic acids having 6 to 20 carbon atoms, and carboxylic acids comprising at least one hydroxyl group with 1 to 20 carbon atoms are preferred.

However, the above polyester chain is not limited to a structure derived from polyester obtained by lactone ring-opening polymerization. It can have a structure derived from polyester obtained by a known polyester synthesis method such as polycondensation of a polyvalent carboxylic acid and polyhydric alcohol or polycondensation of a hydroxycarboxylic acid.

From the perspective of facilitating control of the 1-bromonaphthylene contact angle, the number average molecular weight of the polyester chain is desirably greater than or equal to 200, preferably greater than or equal to 400, and more preferably, greater than or equal to 500. From the same perspective, the number average molecular weight of the polyester chain is desirably less than or equal to 100,000, preferably less than or equal to 50,000. The term “number average molecular weight of the polyester chain” refers to a value that is obtained by hydrolyzing the polyalkyleneimine polymer to obtain a polyester, using gel permeation chromatography (GPC), and converting to a standard polystyrene conversion. The value that is thus obtained is identical to or similar to the value that is obtained by subjecting the polyester that is used to synthesize the polyalkyleneimine polymer to gel permeation chromatography (GPC) and converting to a standard polystyrene conversion. Accordingly, the number average molecular weight calculated for the polyester employed to synthesize the polyalkyleneimine polymer can be adopted as the number average molecular weight of the polyester chain contained in the polyalkyleneimine polymer. Reference can be made to the conditions used to measure the number average molecular weight of the polyester in Examples given further below for the conditions used to measure the number average molecular weight of the polyester chain.

(1-3-1-c. Weight Average Molecular Weight of the Polyalkyleneimine Polymer)

The molecular weight of the polyalkyleneimine polymer is, for example, greater than or equal to 1,000, and also by way of example, less than or equal to 80,000, as a weight average molecular weight. The weight average molecular weight of the polyalkyleneimine polymer is desirably greater than or equal to 1,500, preferably greater than or equal to 2,000, and more preferably, greater than or equal to 3,000. In one embodiment, the weight average molecular weight of the polyalkyleneimine polymer is desirably less than or equal to 60,000, preferably less than or equal to 40,000, more preferably less than or equal to 35,000, and still more preferably, less than or equal to 34,000.

In the present invention, the term “weight average molecular weight of the polyalkyleneimine polymer” refers to a value that is obtained by gel permeation chromatography (GPC) and converted to the standard styrene conversion. Reference can be made to Examples further below for measurement conditions.

(1-3-1-d. Synthesis Methods)

The synthesis method of the polyalkyleneimine polymer is not specifically limited. An example of a desirable embodiment of synthesis method is the method of reacting polyalkyleneimine (referred to as “component A-1”, hereinafter) with polyester (referred to as “component A-2”, hereinafter).

Component A-1 desirably has a number average molecular weight set forth above for the polyalkyleneimine chain. The details of the measurement method, desirable range, and the like of the number average molecular weight of component A-1 are the same as those set forth for the polyalkyleneimine chain above.

Polyalkyleneimine is a polymer that can be obtained by alkyleneimine ring-opening polymerization, as set forth above. The details of the structure of polyalkyleneimine are as set forth for the polyalkyleneimine chain above.

The same one, two, or more types of different alkyleneimines can be employed as the alkyleneimines yielding polyalkyleneimine by ring-opening polymerization. Details regarding the number of carbon atoms of the alkyleneimine are as set forth above for a1, a2, and a3 in formulas A, B, and C. Alkyleneimines with 2 to 4 carbon atoms are desirably employed. Alkyleneimines with 2 or 3 carbon atoms are preferred. An alkyleneimine with two carbon atoms, that is, ethyleneimine, is of greater preference. The number of carbon atoms in an alkyleneimine refers to the number of carbon atoms in the ring structure.

The polyalkyleneimine employed as component A-1 can be synthesized by known methods or obtained as a commercial product.

Component A-2 is polyester. A polyester chain can be imparted to the polyalkyleneimine polymer by means of component A-2. Details regarding the measurement method, desirable range, and the like of the number average molecular weight of component A-2 are as set forth above for the polyester chain.

Component A-2 can react with the polyalkyleneimine by having one or more functional groups capable of reacting with the polyalkyleneimine. As set forth above, in the polyalkyleneimine polymer thus formed, the polyester chain desirably bonds with the alkyleneimine chain constituting the polyalkyleneimine chain by means of —N—(C═O)— or a salt crosslinking group. To impart such a bond, the functional group of the polyester is desirably in the form of a monovalent acidic group. In this context, the term “acidic group” refers to a group that is capable of dissociating into an anion by releasing H⁺ in water in a solvent containing water (aqueous solvent). Such groups can form bonds with polyalkyleneimine chains or form salt crosslinking groups. Specific examples are a carboxyl group, sulfonic acid group, phosphoric acid group, and salts thereof. A carboxyl group and carboxyl salt group are desirable. In this context, the form of the salt of a carboxyl group (—COOH) means a carboxyl salt group in which the M in —COOM denotes a cation such as an alkali metal ion. The same applies to the forms of salts of other acidic groups. From the perspective of introducing a polyester chain capable of effectively functioning as a steric repulsion chain, the number of the functional groups contained in component A-2 is desirably 1. From the same perspective, the functional group is desirably incorporated as a terminal functional group in component A-2.

The acidic group has been specified above with regard to water or an aqueous solvent. However, the polyalkyleneimine polymer is not limited to those that can be employed in a water-based (in this context, the term “based” is used to mean “containing”) solvent. It can desirably be employed in non-water-based solvents. The solvent contained in the coating composition for various layers such as a magnetic layer and a nonmagnetic layer described further below is not limited to water-based solvents. It can be a non-water-based solvent, and is desirably a non-water-based solvent.

Details of the structure of the polyester are as set forth for the polyester chain above. The above-described polyester can be synthesized by known methods or can be obtained as a commercial product. For example, polyester having a terminal functional group in the form of a carboxyl group can be obtained by the method of conducting lactone ring-opening polymerization in the presence of a nucleophilic reagent such as carboxylic acid. With regard to the polyester synthesis conditions, known techniques can be applied without limitation. The polyester having a carboxyl group as a terminal functional group can be bonded with the alkyleneimine chain denoted by formula A by means of —N—(C═O)—. It can also be bonded with the alkyleneimine denoted by formula B by means of the above-described salt crosslinking group. Details such as specific examples of carboxylic acids and the like are as set forth above.

The reaction of above-described components A-1 and A-2 can be conducted by known polymerization methods such as solution polymerization and the like. For example, it can be conducted by stirring and mixing components A-1 and A-2, optionally in the presence of an organic solvent. The reaction can progress without a solvent. For example, a reaction solution containing components A-1 and A-2 can be heated (to a heating temperature of 50° C. to 200° C., for example) while being stirred in air or in a nitrogen atmosphere, or heated (to a heating temperature of 40° C. to 150° C., for example) while adding a catalyst such as an organic tin compound such as monobutyltin oxide, an ammonium salt such as trimethylammonium bromide, a tertiary amine such as benzyldimethylamine, or a quaternary ammonium salt, to conduct the reaction. Examples of organic solvents are ethyl acetate, chloroform, tetrahydrofuran, methyl ethyl ketone, acetone, acetonitrile, and toluene.

(1-3-1-e. Other Polymer Chain)

The polyalkyleneimine polymer can comprise one or more polymer chains other than a polyester chain, and can comprise both a polyester chain and a polymer chain other than a polyester chain. The same method as that set forth above for introducing a polyester chain can be used to introduce such a polymer chain into a polyalkyleneimine polymer.

(1-3-2. Amine Polymers)

The polyalkyleneimine polymer set forth above is a type of amine polymer. However, an amine polymer other than the amine polymer of the polyalkyleneimine polymer can also be employed. Alternatively, a polyalkyleneimine polymer can be employed in combination with another amine polymer.

The amine polymer can be a primary amine denoted by NH₂R, a secondary amine denoted by NHR₂, or a tertiary amine denoted by NR₃. In these formulas, R denotes any structure constituting an amine polymer. A plurality of R being present can be identical or different. The present inventors assume that the nitrogen-containing moiety of an amine polymer can function as an adsorption moiety on the surface of particles of ferromagnetic powder.

Examples of the polymer chain that is present on the amine polymer are various polymer chains such as polyester chains, polyamide chains, and polyurethane chains. A hydrophobic chain is desirable. The number average molecular weight of the polymer chain desirably falls within the range given for the polyester chain of the polyalkyleneimine polymer set forth above. Amine polymers synthesized by known methods, as well as commercial products, can be employed. Specific examples of commercial products are ANTI-TERRA-U/U100, ANTI-TERRA-204/205, DISPERBYK-101, DISPERBYK-102, DISPERBYK-103, DISPERBYK-106, DISPERBYK-108, DISPERBYK-109, DISPERBYK-110, DISPERBYK-111, DISPERBYK-112, DISPERBYK-116, DISPERBYK-130, DISPERBYK-140, DISPERBYK-142, DISPERBYK-145, DISPERBYK-161, DISPERBYK-162, DISPERBYK-163, DISPERBYK-164, DISPERBYK-166, DISPERBYK-160, DISPERBYK-167, DISPERBYK-168, DISPERBYK-170, DISPERBYK-171, DISPERBYK-174, DISPERBYK-180, DISPERBYK-182, DISPERBYK-183, DISPERBYK-184, DISPERBYK-185, DISPERBYK-2000, DISPERBYK-2001, DISPERBYK-2020, DISPERBYK-2050, DISPERBYK-2070, DISPERBYK-2096, DISPERBYK-2150, BYK-P104, BYK-P105, BYK-9076, BYK-9077, BYK-2205, manufactured by BYK Japan.

(1-4. Ferromagnetic Powder)

The ferromagnetic powder that is contained in the magnetic layer along with the lubricant and contact angle adjusting agent will be described next.

From the perspective of high density recording, the ferromagnetic powder desirably has an average particle size of less than or equal to 50 nm. From the perspective of stable magnetization, the average particle size of the ferromagnetic powder is desirably greater than or equal to 10 nm.

The average particle size of the ferromagnetic powder is a value that is measured by the following method with a transmission electron microscope.

Ferromagnetic powder is photographed at a magnification of 100,000-fold with a transmission electron microscope, and the photograph is printed on print paper at a total magnification of 500,000-fold to obtain a photograph of the particles constituting the ferromagnetic powder. A target particle is selected from the photograph of particles that has been obtained, the contour of the particle is traced with a digitizer, and the size of the (primary) particle is measured. The term “primary particle” refers to an unaggregated, independent particle.

The above measurement is conducted on 500 randomly extracted particles. The arithmetic average of the particle size of the 500 particles obtained in this manner is adopted as the average particle size of the ferromagnetic powder. A Model H-9000 transmission electron microscope made by Hitachi can be employed as the above transmission electron microscope, for example. The particle size can be measured with known image analysis software, such as KS-400 image analysis software from Carl Zeiss.

In the present invention, the average particle size of the powder is the average particle size as obtained by the above method. The average particle size indicated in Examples further below was obtained using a Model H-9000 transmission electron microscope made by Hitachi and KS-400 image analysis software made by Carl Zeiss.

The method described in paragraph 0015 of Japanese Unexamined Patent Publication (KOKAI) No. 2011-048878, which is expressly incorporated herein by reference in its entirety, for example, can be employed as the method of collecting sample powder such as ferromagnetic powder from a magnetic layer for particle size measurement.

In the present invention, the size of the particles constituting powder such as ferromagnetic powder (referred to as the “particle size”, hereinafter) is denoted as follows based on the shape of the particles observed in the above particle photograph:

(1) When acicular, spindle-shaped, or columnar (with the height being greater than the maximum diameter of the bottom surface) in shape, the particle size is denoted as the length of the major axis constituting the particle, that is, the major axis length.
(2) When platelike or columnar (with the thickness or height being smaller than the maximum diameter of the plate surface or bottom surface) in shape, the particle size is denoted as the maximum diameter of the plate surface or bottom surface.
(3) When spherical, polyhedral, of unspecific shape, or the like, and the major axis constituting the particle cannot be specified from the shape, the particle size is denoted as the diameter of an equivalent circle. The term “diameter of an equivalent circle” means that obtained by the circle projection method.

The “average acicular ratio” of a powder refers to the arithmetic average of values obtained for the above 500 particles by measuring the length of the minor axis, that is the minor axis length, of the particles measured above, and calculating the value of the (major axis length/minor axis length) of each particle. The term “minor axis length” refers to, in the case of the particle size definition of (1), the length of the minor axis constituting the particle; in the case of (2), the thickness or height, and in the case of (3), since the major axis and minor axis cannot be distinguished, (major axis length/minor axis length) is deemed to be 1 for the sake of convenience.

When the particle has a specific shape, such as in the particle size definition of (1) above, the average particle size is the average major axis length. In the case of (2), the average particle size is the average plate diameter, with the average plate ratio being the arithmetic average of (maximum diameter/thickness or height). For the definition of (3), the average particle size is the average diameter (also called the average particle diameter).

Hexagonal ferrite powder is a specific example of desirable ferromagnetic powder. From the perspectives of achieving higher density recording and magnetization stability, the average particle size (average plate diameter) of hexagonal ferrite powder desirably ranges from 10 nm to 50 nm, preferably 20 nm to 50 nm. Reference can be made to Japanese Unexamined Patent Publication (KOKAI) No. 2011-216149, paragraphs 0134 to 0136, for details on hexagonal ferrite powder.

Ferromagnetic metal powder is also a specific example of desirable ferromagnetic powder. From the perspectives of achieving higher density recording and magnetization stability, the average particle size (average major axis length) of ferromagnetic metal powder desirably ranges from 10 nm to 50 nm, preferably 20 nm to 50 nm. Reference can be made to Japanese Unexamined Patent Publication (KOKAI) No. 2011-216149, paragraphs 0137 to 0141, for details on ferromagnetic metal powder.

The content (fill rate) of ferromagnetic powder in the magnetic layer desirably falls within a range of 50 to 90 weight percent, preferably within a range of 60 to 90 weight percent. A high fill rate is desirable from the perspective of increasing the recording density.

(1-5. Binder)

The magnetic recording medium of an aspect of the present invention is desirably a particulate magnetic recording medium. A particulate magnetic recording medium is a magnetic recording medium having coated layer(s) containing binder. The binder employed can be in the form of polyurethane resin, polyester resin, polyamide resin, vinyl chloride resin, styrene, acrylonitrile, methyl methacrylate, and other copolymerized acrylic resins; nitrocellulose and other cellulose resins; epoxy resin; phenoxy resin; polyvinyl acetal, polyvinyl butyral, and other polyvinyl alkyrals; these resins can be employed singly or two or more resins can be mixed for use. Of these, the polyurethane resins, acrylic resins, cellulose resins, and vinyl chloride resins are desirable. These resins can also be employed as binders in the nonmagnetic layer, described further below. Reference can be made to Japanese Unexamined Patent Publication (KOKAI) No. 2010-24113, which is expressly incorporated herein by reference in its entirety, paragraphs 0028 to 0031, with regard to the binders.

Reference can be made to Japanese Unexamined Patent Publication (KOKAI) No. 2014-080563, paragraphs 0014 to 0027, and Examples given in the same; and the description of Examples in Japanese Unexamined Patent Publication (KOKAI) No. 2013-065381, paragraphs 0012 to 0016 and 0040 to 0136, with regard to binders. The binder content, for example, can fall within a range of 5.0 to 50.0 weight parts, desirably within a range of 10.0 to 30.0 weight parts, per 100.0 weight parts of ferromagnetic powder. The contents of the above publications are expressly incorporated herein by reference in their entirety.

It is also possible to employ a curing agent with the above resins. Polyisocyanates are suitable as curing agents. Reference can be made to Japanese Unexamined Patent Publication (KOKAI) No. 2011-216149, paragraphs 0124 and 0125, for details regarding polyisocyanates. The content of the above publication is expressly incorporated herein by reference in its entirety. The curing agent can be employed, for example, by adding a quantity of 0 to 80 weight parts, desirably 50.0 weight parts to 80.0 weight parts from the perspective of enhancing the coating strength, per 100.0 weight parts of binder to the coating composition for forming the magnetic layer.

(1-6. Additives)

The magnetic layer contains a lubricant and a contact angle adjusting agent, and as needed, can also contain other additive(s). Examples of additives are abrasives, dispersing agents, dispersion adjuvants, antifungal agents, antistatic agents, oxidation inhibitors, and carbon black. Additives can be suitably selected for use from among commercial products based on the physical properties that are desired.

Examples of additives are the dispersing agents for enhancing the dispersion of abrasives that are described in Japanese Unexamined Patent Publication (KOKAI) No. 2013-131285, paragraphs 0012 to 0022. Reference can be made to paragraphs 0023 and 0024 of the same for abrasives. The content of the above publication is expressly incorporated herein by reference in its entirety.

Further examples are nonmagnetic fillers. Nonmagnetic fillers can function as agents that form suitable protrusions on the surface of the magnetic layer. Inorganic oxide powders and inorganic oxide colloidal particles can be employed as nonmagnetic fillers. Reference can be made to Japanese Unexamined Patent Publication (KOKAI) No. 2011-048878, paragraphs 0013 to 0028 with regard to nonmagnetic fillers. The content of the above publication is expressly incorporated herein by reference in its entirety. The average particle size of the colloidal silica indicated in Examples given further below is a value that is obtained by the method described as the average particle diameter measurement method in Japanese Unexamined Patent Publication (KOKAI) No. 2011-048878, paragraph 0015. The coefficient of variation is a value calculated by the method described in the same paragraph. The sphericity is a value that is calculated by the method described as the method of measuring the degree of roundness in paragraph 0020 of the same.

The magnetic layer described above is provided on a nonmagnetic layer on a nonmagnetic support. Details regarding the nonmagnetic layer and nonmagnetic support will be provided further below.

<2. Nonmagnetic Layer>

Details of the nonmagnetic layer will be described next. In the magnetic recording medium of an aspect of the present invention, a nonmagnetic layer containing nonmagnetic powder and binder is present between the nonmagnetic support and the magnetic layer. Either inorganic substances or organic substances can be employed as the nonmagnetic powder in the nonmagnetic layer. Carbon black can also be employed. Examples of inorganic substances are metals, metal oxides, metal carbonates, metal sulfates, metal nitrides, metal carbides, and metal sulfides. These nonmagnetic powders are available as commercial products and can be manufactured by known methods. Reference can be made to Japanese Unexamined Patent Publication (KOKAI) No. 2011-216149, paragraphs 0146 to 0150 and Japanese Unexamined Patent Publication (KOKAI) No. 2013-049832, paragraphs 00019 to 0020, for details in that regard. The contents of the above publications are expressly incorporated herein by reference in their entirety.

The content of nonmagnetic powder in the nonmagnetic layer desirably falls within a range of 50 to 90 weight percent, preferably within a range of 60 to 90 weight percent.

The binders, lubricants, dispersing agents, other additives, solvents, dispersion methods, and the like of the magnetic layer can be applied to the nonmagnetic layer. Specifically, techniques known with regard to the magnetic layer regarding the quantity and type of binder and the quantities and types of additives and dispersing agents can be applied. It is also possible to add carbon black and organic powders to the nonmagnetic layer. Reference can be made to Japanese Unexamined Patent Publication (KOKAI) No. 2010-24113, paragraphs 0040 to 0042, in that regard. The content of the above publication is expressly incorporated herein by reference in its entirety.

The nonmagnetic layer also desirably contains a lubricant. As set forth above, this is because the nonmagnetic layer can function as a tank for supplying lubricant to the magnetic layer. Reference can be made to the magnetic layer set forth above with regard to lubricants that can be added to the nonmagnetic layer. The content of lubricant in the nonmagnetic layer is, for example, 1.0 to 6.0 weight parts, desirably 1.5 to 5.5 weight parts, and preferably, 2.0 to 5.0 weight parts, per 100.0 weight parts of nonmagnetic powder. Carbon black has a stronger tendency not to adsorb lubricant than the various nonmagnetic powders that can be employed as nonmagnetic powders in the nonmagnetic layer. The fact that a nonmagnetic powder tends not to adsorb lubricant relates to increasing the quantity of lubricant that migrates from the nonmagnetic layer to the magnetic layer, and onto the surface of the magnetic layer. Accordingly, when increasing the quantity of lubricant on the surface of the magnetic layer to control the 1-bromonaphthalene contact angle and water contact angle, carbon black is desirably employed as some portion, or all, of the nonmagnetic powder in the nonmagnetic layer.

Additives that are capable of functioning as dispersing agents to enhance the dispersion of nonmagnetic powder are examples of additives in the nonmagnetic layer. Examples of such additives are organic tertiary amines. Organic tertiary amines are desirably added to a nonmagnetic layer containing carbon black as nonmagnetic powder. Their addition can enhance dispersion of the carbon black. Reference can be made to Japanese Unexamined Patent Publication (KOKAI) No. 2013-049832, paragraphs 0011 to 0018 and 0021, with regard to organic tertiary amines. Reference can be made to the same publication, paragraphs 0022 to 0024 and 0027 with regard to the formula of a composition for increasing the dispersion of carbon black by means of an organic tertiary amine. The content of the above publication is expressly incorporated herein by reference in its entirety.

<3. Backcoat Layer>

A backcoat layer can be present on the opposite surface of the nonmagnetic support from the surface on which the magnetic layer is present in the magnetic recording medium of an aspect of the present invention. The backcoat layer desirably contains carbon black or carbon black and an inorganic powder. The formulas of the magnetic layer and nonmagnetic layer can be applied to the binder and various additives used to form the backcoat layer.

In one embodiment, a lubricant can be incorporated into the backcoat layer. Reference can be made to the description set forth above regarding the magnetic layer for lubricants that can be added to the backcoat layer.

Magnetic recording media can be roughly divided into tapes and disks. Those in the form of tapes (magnetic tapes) are usually wound on a reel inside a magnetic tape cartridge. In magnetic tapes having a backcoat layer, the surface of the magnetic layer comes in contact with the surface of the backcoat layer when in a wound state, making it possible for lubricant to transfer from the surface of the backcoat layer to the surface of the magnetic layer. Accordingly, incorporating a lubricant into the backcoat layer can become one way to control the 1-bromonaphthalene contact angle and water contact angle. Providing an over coat of lubricant on the surface of the backcoat layer and causing the lubricant to be unevenly distributed in the surface of the backcoat layer can be another example of a way to control the 1-bromonaphthalene contact angle and water contact angle. Compared to the first way, the second way tends to cause a larger quantity of lubricant to transfer from the surface of the backcoat layer to the surface of the magnetic layer.

In embodiments in which lubricant is added to the backcoat layer, and in embodiments in which an over coat of lubricant is provided on the surface of the backcoat layer, the quantity of lubricant is, for example, 1.0 to 6.0 weight parts, desirably 2.0 to 5.0 weight parts, and preferably, 2.5 to 4.5 weight parts, per 100.0 weight parts of the combined content of the carbon black and inorganic powder contained in the backcoat layer (the content of carbon black when only carbon black is employed).

<4. Nonmagnetic Support>

Details of the nonmagnetic support will be described next. Examples of nonmagnetic supports are known supports such as biaxially stretched polyethylene terephthalate, polyethylene naphthalate, polyamide, polyamide-imide, and aromatic polyamide. Of these, polyethylene terephthalate, polyethylene naphthalate, and polyamide are desirable.

These supports can be subjected to corona discharge, plasma treatment, adhesion-enhancing treatment, heat treatment and the like in advance.

<5. Thickness of the Various Layers and Nonmagnetic Support>

The thickness of the nonmagnetic support is desirably 3.00 to 80.00 μm, preferably 3.00 to 50.00 μm, and more preferably, 3.00 to 10.00 μm.

The thickness of the magnetic layer can be optimized based on the saturation magnetization level of the magnetic head employed, the head gap length, and the recording signal bandwidth. To achieve high-density recording, it is desirably 0.01 to 0.10 μm, preferably 0.02 to 0.09 μm. The magnetic layer is comprised of at least one layer, and can be divided into two or more layers with different magnetic characteristics. The structure of a known multilayer magnetic layer can be applied.

The thickness of the nonmagnetic layer is, for example, greater than or equal to 0.05 μm, desirably greater than or equal to 0.07 μm, and preferably, greater than or equal to 0.10 μm. The thickness of the nonmagnetic layer is desirably less than or equal to 0.80 μm, preferably less than or equal to 0.50 μm. In a magnetic tape, it is desirable for the total thickness of the magnetic tape to be thin so as to increase the recording capacity per magnetic tape cartridge. Reducing the thickness of the nonmagnetic layer relates to decreasing the total thickness and is thus desirable. When the thickness of a nonmagnetic layer that is capable of functioning as a tank to supply lubricant to the magnetic layer is reduced, the amount of lubricant that is fed from the nonmagnetic layer to the magnetic layer sometimes tends to decrease. However, by increasing the quantity of lubricant in the magnetic layer and backcoat layer; using carbon black, which tends not to adsorb lubricant, as nonmagnetic powder in the nonmagnetic layer; increasing the proportion of nonmagnetic powder accounted for by carbon black, and the like, it is possible to control the 1-bromonaphthalene contact angle and water contact angle to within the respective ranges given above.

The nonmagnetic layer in the present invention includes an essentially nonmagnetic layer containing trace quantities of ferromagnetic powder, for example, either as impurities or intentionally, in addition to the nonmagnetic powder. The essentially nonmagnetic layer means a layer exhibiting a residual magnetic flux density of equal to or less than 10 mT, a coercive force of equal to or less than 7.96 kA/m (100 Oe), or a residual magnetic flux density of equal to or less than 10 mT and a coercive force of equal to or less than 7.96 kA/m (100 Oe). The nonmagnetic layer desirably has no residual magnetic flux density or coercive force.

The backcoat layer is desirably equal to or less than 0.90 μm, preferably 0.10 to 0.70 μm in thickness.

The thickness of the various layers of the magnetic recording medium and the nonmagnetic support can be determined by known film thickness measuring methods. As an example, a cross-section in the direction of thickness of the magnetic recording medium can be exposed by a known technique such as an ion beam or microtome, and the exposed cross-section can be observed with a scanning electron microscope. The various thicknesses can be determined at one spot in the direction of thickness by cross-section observation, or as the arithmetic averages of thicknesses determined at two or more spots. The thickness of each layer can also be determined as the design thickness calculated from the manufacturing conditions.

<6. Surface Roughness of the Magnetic Layer>

From the perspective of achieving higher density recording, in one embodiment of the magnetic recording medium of an aspect of the present invention, the centerline average surface roughness Ra as measured by an atomic force microscope on the surface of the magnetic layer is desirably less than or equal to 3.0 nm, preferably less than or equal to 2.7 nm, and more preferably, less than or equal to 2.5 nm. For example, the centerline average surface roughness Ra as measured by an atomic force microscope on the surface of the magnetic layer is desirably greater than or equal to 1.0 nm. However, as set forth above, the less rough the surface of the magnetic layer becomes and the smoother the surface of the magnetic layer becomes, the greater the friction during sliding of the surface of the magnetic layer and the head becomes and the greater the tendency of running durability to decrease. Even in such cases, it is possible to achieve good running durability by controlling the 1-bromonaphthalene contact angle and water contact angle to within the above ranges.

The surface roughness of the magnetic layer can be decreased by increasing the dispersion of the various components in the magnetic layer and nonmagnetic layer. It can also be reduced by surface treating the surface of the magnetic layer. An example of a surface treatment of the magnetic layer is a polishing treatment employing the polishing means described in Japanese Unexamined Patent Publication (KOKAI) Heisei No. 5-62174. Reference can be made to paragraphs 0005 to 0032 and all of the drawings in that publication. The content of the above publication is expressly incorporated herein by reference in its entirety.

<7. Process of Manufacturing Magnetic Recording Medium>

The magnetic recording medium of an aspect of the present invention can be a particulate magnetic recording medium and can be manufactured using compositions (coating liquids) for forming various layers such as the magnetic layer, nonmagnetic layer, and an optionally provided backcoat layer. A specific form of the process of manufacturing the magnetic recording medium will be described below. However, in the magnetic recording medium of an aspect of the present invention, the 1-bromonaphthalene contact angle and water contact angle of the surface of the magnetic layer need only fall within the ranges set forth above, and there is no limitation to a magnetic recording medium that is manufactured by the manufacturing process of the form given below.

(7-1. Composition for Forming the Magnetic Layer)

The composition (coating liquid) for forming the magnetic layer normally contains a solvent in addition to the various components described above. Examples of the solvent are those organic solvents that are commonly employed to manufacture particulate magnetic recording media. The content of the solvent in the composition for forming the magnetic layer, for example, falls within a range of 100.0 to 800.0 weight parts, desirably within a range of 200.0 to 600.0 weight parts, per 100.0 weight parts of ferromagnetic powder.

The process of preparing the composition for forming the magnetic layer, and the compositions for forming various layers such as the nonmagnetic layer, normally comprises a kneading step, dispersing step, and mixing steps provided before and after these steps as needed. Any of these steps can be divided into two or more stages. All of the starting materials, such as ferromagnetic powder, nonmagnetic powder, binder, carbon black, various additives, and solvents can be added at the beginning of, or during, any step. The various starting materials can be separately added in two or more steps. The composition for forming the magnetic layer is desirably prepared by separately preparing a dispersion (magnetic liquid) containing ferromagnetic powder, a dispersion (abrasive liquid) containing abrasive, and a dispersion (nonmagnetic filler liquid) containing nonmagnetic filler (a protrusion-forming agent), and then simultaneously or successively mixing them with other components such as lubricants. Part or all of the lubricants, curing agents, and solvents can be added to a mixed liquid obtained by mixing the magnetic liquid, abrasive liquid, and nonmagnetic filler liquid. Additionally, reference can be made to Japanese Unexamined Patent Publication (KOKAI) No. 2010-231843, paragraph 0065, with regard to preparation of the compositions for forming the various layers. The content of the above publication is expressly incorporated herein by reference in its entirety.

(7-2. Composition for Forming the Nonmagnetic Layer and Composition for Forming the Backcoat Layer)

The nonmagnetic layer can be formed by, for example, directly coating the composition (coating liquid) for forming the nonmagnetic layer on the surface of a nonmagnetic support. In addition to the various components set forth above, the composition for forming the nonmagnetic layer normally contains a solvent. Examples of solvents are the organic solvents that are commonly used to manufacture particulate magnetic recording media. Reference can be made to the above description relating to the composition for forming the magnetic layer for additional details about preparing the composition for forming the nonmagnetic layer.

Reference can also be made to the description given above regarding the composition for forming the magnetic layer in regard to details on preparing the composition (coating liquid) for forming the backcoat layer.

(7-3. Coating Step)

The magnetic layer can be formed by successively or simultaneously multilayer coating the composition for forming the magnetic layer and the composition for forming the nonmagnetic layer. Reference can be made to Japanese Unexamined Patent Publication (KOKAI) No. 2010-231843, paragraph 66, for details regarding coatings to form the various layers. The content of the above publication is expressly incorporated herein by reference in its entirety.

(7-4. Other Steps)

Reference can be made to Japanese Unexamined Patent Publication (KOKAI) No. 2010-231843, paragraphs 0067 to 0070, for various other steps in manufacturing a magnetic recording medium. Reference can be made to Japanese Unexamined Patent Publication (KOKAI) Heisei No. 5-62174, as set forth above, regarding surface treatment of the surface of the magnetic layer. The contents of the above publications are expressly incorporated herein by reference in their entirety.

The magnetic recording medium of an aspect of the present invention as set forth above can inhibit the generation of head fouling (lubricant and shavings from the surface of the magnetic layer) that cause spacing loss in contact sliding type magnetic recording and reproduction systems in which the surface of the magnetic layer comes in contact with the surface of the head during the recording and reproduction of signals.

### EXAMPLES

The present invention will be described in detail below based on Examples. However, the present invention is not limited to embodiments shown in Examples. The terms “parts” and “percent” given in Examples are weight parts and weight percent unless otherwise stated.

The synthesis product synthesized by the following method was employed as 1-bromonaphthalene contact angle adjusting agent A below.

The commercial amine polymer (DISPERBYK-102 made by BYK Japan) was employed as 1-bromonaphthalene contact angle adjusting agent B below.

### I. Example of Synthesizing 1-Bromonaphthalene Contact Angle Adjusting Agent A

The acid values and amine values given below were determined by the electrical potential method (solvent: tetrahydrofuran/water=100/10 (volumetric ratio), titration solution: 0.01 N (0.01 mol/L) sodium hydroxide aqueous solution (acid value), 0.01 N (0.01 mol/L) hydrochloric acid (amine value)).

The number average molecular weight and weight average molecular weight were measured by GPC and converted to standard polystyrene conversion values.

The various measurement conditions for the average molecular weight of polyester, polyalkyleneimine, and polyalkyleneimine polymer were as given below.

### (Measurement Conditions for Average Molecular Weight of Polyester)

Measurement apparatus: HLC-8220 GPC (made by Tosoh Corp.)

Column: TSKgel Super HZ 2000/TSKgel Super HZ 4000/TSKgel Super HZ-H (made by Tosoh Corp.)

Eluent: Tetrahydrofuran (THF)

Flow rate: 0.35 mL/min

Column temperature: 40° C.

Detector: Differential refractive (RI) detector

(Measurement Conditions for Average Molecular Weight of Polyalkyleneimine and Average Molecular Weight of Polyalkyleneimine Polymer)

Measurement apparatus: HLC-8320 GPC (made by Tosoh Corp.)

Column: Three TSKgel Super AWM-Hs (made by Tosoh Corp.)

Eluent: N-methyl-2-pyrrolidone (with 10 mM lithium bromide added as additive)

Flow rate: 0.35 mL/min

Column temperature: 40° C.

Detector: RI

The number average molecular weight of the polyalkyleneimine chain can be determined by the following method.

Synthesized polyalkyleneimine polymer is hydrolyzed by an ester hydrolysis method such as the acid hydrolysis method described in “Experimental Chemistry Lecture 16 Synthesis of Organic Compounds IV—Carboxylic Acids. Amino Acids.Peptides (5th Ed.),” (compiled by the Chemical Society of Japan, Maruzen Publishing, released March 2005), on page 11. Polyalkyleneimine is separated by liquid chromatography from the hydrolysis product obtained, and the number average molecular weight measured under the above measurement conditions can be adopted as the number average molecular weight of the polyalkyleneimine contained in the polyalkyleneimine polymer.

(Synthesis of Polyester (i-1))

In a 500 mL, three-necked flask were mixed 16.8 g of carboxylic acid in the form of n-octanoic acid (Wako Pure Chemical Industries, Ltd.), 100 g of lactone in the form of ε-caprolactone (Praxel M made by Daicel Chemical Industries, Inc.), and 2.2 g of catalyst in the form of monobutyltin oxide (Wako Pure Chemical Industries, Ltd.) (C₄H₉Sn(O)OH) and the mixture was heated for 1 hour at 160° C. A 100 g quantity of ε-caprolactone was added dropwise over 5 hours and the mixture was stirred for another two hours. Subsequently, the mixture was cooled to room temperature, yielding polyester (i-1).

The synthesis schema is indicated below.

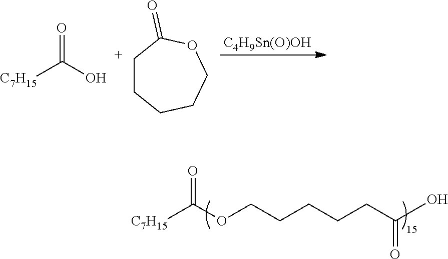

The number average molecular weight and weight average molecular weight of the polyester obtained are given in Table 1 below. The number of units of lactone repeating unit that was calculated from the starting material charge ratio is also given in Table 1.

(Synthesis of Polyethyleneimine Polymer (1-Bromonaphthalene Contact Angle Adjusting Agent A))

A 2.4 g quantity of polyethyleneimine (SP-006, made by Nippon Shokubai Co., number average molecular weight 600) and 100 g of polyester (i-1) were mixed and heated for 3 hours at 110° C., yielding polyethyleneimine polymer.

Based on the results of two forms of NMR analysis, ¹H-NMR and ¹³C-NMR, and on the results of elemental analysis by the combustion method conducted on the polyalkyleneimine polymer that was obtained, the ratio (polyalkyleneimine chain ratio) accounted for by the polyalkyleneimine chain in the polyalkyleneimine polymer was calculated. The results are given in Table 1. The calculated polyalkyleneimine chain ratio was the same value as the value calculated from the quantities of polyalkyleneimine and polyester charged.

TABLE 1

| | | | Quantity of | | Weight | Number | |
|---|---|---|---|---|---|---|---|
| | | | carboxylic | | average | average | Number of |
| | | Carboxylic | acid charged | | molecular | molecular | repeating |
| | Polyester | acid | (g) | Lactone | weight | weight | lactone units |
| Synthesis of | (i-1) | n-octanoic | 16.8 | ε- | 7,000 | 5,800 | 15 |
| polyester | | acid | | caprolactone | | | |

| | Quantity of | Polyalkyleneimine | | | | |
|---|---|---|---|---|---|---|
| | polyethyleneimine | chain | | | | Weight average |
| | charged | (polyethyleneimine | | Acid value | Amine value | molecular |
| | (g) | chain) ratio | Polyester | (mgKOH/g) | (mgKOH/g) | weight |
| Synthesis of | 2.4 | 2.3 | (i-1) | 35.0 | 17.4 | 7,000 |
| polyalkyleneimine | | | | | | |
| (polyethyleneimine) | | | | | | |
| polymer | | | | | | |

### II. Example of Fabrication of Magnetic Tape

### Example 1

The formulas of the compositions for forming the various layers are given below.

(Composition for forming magnetic layer)

(Magnetic liquid)

| | | |
|---|---|---|
| Ferromagnetic powder (ferromagnetic hexagonal barium | 100.0 | parts |
| ferrite powder A): (Hc: 196 kA/m (2,460 Oe), average | | |
| particle size (average plate diameter) 24 nm) | | |
| Oleic acid: | 2.0 | parts |
| Vinyl chloride copolymer (MR-104, Zeon Corp.): | 10.0 | parts |
| SO₃Na group-containing polyurethane resin: | 4.0 | parts |
| (weight average molecular weight: 70,000; SO₃Na groups: | | |
| 0.07 meq/g) | | |
| 1-Bromonaphthalene contact angel adjusting agent A: | 10.0 | parts |
| Methyl ethyl ketone: | 150.0 | parts |
| Cyclohexanone: | 150.0 | parts |

(Abrasive liquid)

| | | |
|---|---|---|
| α-Alumina (specific surface area: 19 m²/g, sphericity: 1.4): | 6.0 | parts |
| SO₃Na group-containing polyurethane resin | | |
| (weight average molecular weight 70,000; SO₃Na groups: | 0.6 | part |
| 0.1 meq/g): | | |
| 2,3-Dihydroxynaphthalene: | 0.6 | part |
| Cyclohexanone: | 23.0 | parts |

(Nonmagnetic filler liquid)

| | | |
|---|---|---|
| Colloidal silica (average particle size: 120 nm, coefficient | 2.0 | parts |
| of variation = 7%, sphericity: 1.03) | | |
| Methyl ethyl ketone: | 8.0 | parts |

(Lubricant - curing agent liquid)

| | | |
|---|---|---|
| Stearic acid: | 3.0 | parts |
| Amide stearate: | 0.3 | part |
| Butyl stearate: | 6.0 | parts |
| Methyl ethyl ketone: | 110.0 | parts |
| Polyisocyanate (Coronate (Japanese registered trademark) | 3 | parts |
| L, made by Nippon Polyurethane Industry Co., Ltd.): | | |

(Composition a for Forming Nonmagnetic Layer A)

| | | |
|---|---|---|
| Carbon black (average particles (average primary particular | 100.0 | parts |
| size) 16 nm, DBP (dibutyl phthalate) oil absorption | | |
| capacity: 74 cm³/100 g): | | |
| Trioctylamine: | 4.0 | parts |
| Vinyl chloride copolymer (MR-104, made by Zeon Corp.): | 19.0 | parts |
| SO₃Na group-containing polyurethane resin | 12.0 | parts |
| (weight average molecular weight: 50,000; SO₃Na groups: | | |
| 0.07 meq/g): | | |
| Methyl ethyl ketone: | 370.0 | parts |
| Cyclohexanone: | 370.0 | parts |
| Stearic acid: | 2.0 | parts |
| Amide stearate: | 0.3 | part |
| Butyl stearate: | 2.0 | parts |

(Composition A for forming backcoat layer A)

| | | |
|---|---|---|
| Colcothar (average particle size: 0.15 μm, average | 80.0 | parts |
| acicular ratio: 7, specific surface area as measured by | | |
| BET method (S_{BET}): 52 m²/g): | | |
| Carbon black (average particle size (average primary | 20.0 | parts |
| particle size) 16 nm, DBP oil absorption capacity: | | |
| 74 cm³/100 g): | | |
| Phenylphosphonic acid: | 3.0 | parts |
| Vinyl chloride copolymer (MR-104, made by Zeon | 12.0 | parts |
| Corp.): | | |
| SO₃Na group-containing polyurethane resin (weight | 8.0 | parts |
| average molecular weight: 50,000; SO₃Na groups: | | |
| 0.07 meq/g): | | |
| Alumina powder (α-alumina with specific surface | 5.0 | parts |
| area of 17 m²/g): | | |
| Methyl ethyl ketone: | 370.0 | parts |
| Cyclohexanone: | 370.0 | parts |
| Stearic acid: | 1.0 | part |
| Amide stearate: | 0.3 | part |
| Butyl stearate: | 2.0 | parts |
| Polyisocyanate (Coronate L made by Nippon | 5 | parts |
| Polyurethane Industry Co., Ltd.): | | |

(Preparation of Composition for Forming Magnetic Layer)

The composition for forming the magnetic layer was prepared by the following method.

The above magnetic liquid was kneaded and dilution processed in an open kneader, and then subjected to 30 passes of dispersion treatment with a single pass residence time of 2 minutes, rotor tip peripheral speed of 10 m/s, and bead fill rate of 80% using zirconia (ZrO₂) beads (referred to as “Zr beads” hereinafter) with a 0.1 mm particle diameter in a horizontal bead mill disperser.

For the abrasive liquid, the above components were mixed and the mixture was charged along with Zr beads 0.3 mm in bead diameter to a horizontal bead mill disperser. Adjustment was made to a bead volume/(abrasive liquid volume+bead volume) of 80% and bead mill dispersion processing was conducted for 120 minutes. Following processing, the liquid was collected and subjected to ultrasonic dispersion filtration processing using a flow-type ultrasonic dispersion filtration device.

The magnetic liquid, nonmagnetic filler liquid, and abrasive liquid were placed along with other components in the form of the lubricant-curing agent liquid in a dissolver stirrer, and stirred for 30 minutes at a peripheral speed of 10 m/s. Subsequently, the liquid was subjected to 3 passes at a flow rate of 7.5 kg/minute through a flow-type ultrasonic disperser and filtered through a 1 μm filter to prepare the composition for forming the magnetic layer.

(Preparation of Composition for Forming Nonmagnetic Layer)

The composition for forming the nonmagnetic layer was prepared by the following method.

Excluding the lubricants (stearic acid, amide stearate, and butyl stearate), the above components were kneaded and dilution processed in an open kneader. Subsequently, the mixture was dispersion processed in a horizontal bead mill disperser. Subsequently, the lubricants (stearic acid, amide stearate, and butyl stearate) were added and stifling and mixing were conducted in a dissolver stirrer to prepare the composition for forming the magnetic layer.

(Preparation of Composition a for Forming Backcoat Layer)

The composition for forming the backcoat layer was prepared by the following method.

Excluding the polyisocyanate and lubrications (stearic acid, amide stearate, and butyl stearate), the above components were charged to a dissolver stirrer and stirred for 30 minutes at a peripheral speed of 10 m/s. They were then dispersion processed in a horizontal bead mill disperser. Subsequently, the polyisocyanate and lubricants (stearic acid, amide stearate, and butyl stearate) were added, and the mixture was stirred and mixed in the dissolver stirrer to prepare the composition for forming the backcoat layer.

(Fabrication of Magnetic Tape)

The composition for forming the nonmagnetic layer was coated and dried to a dry thickness of 0.10 μm on a nonmagnetic support (polyamide support) 4.00 μm in thickness. The composition for forming the backcoat layer was then coated and dried to a dry thickness of 0.50 μm on the reverse side of the nonmagnetic support. After being wound on a pickup roll, the nonmagnetic support was heat treated for 36 hours in a 70° C. environment.

Following the heat treatment, the composition for forming the magnetic layer was coated and dried to a dry thickness of 0.07 μm on the nonmagnetic layer.

Subsequently, a surface smoothing treatment (calendering treatment) was conducted at a temperature of 100° C., linear pressure of 300 kg/cm (294 kN/m), and speed of 40 m/min using a calender comprised of only metal rolls. Subsequently, a heat treatment was conducted for 36 hours in an environment of 70° C. Following the heat treatment, the product was slit to ½ inch width.

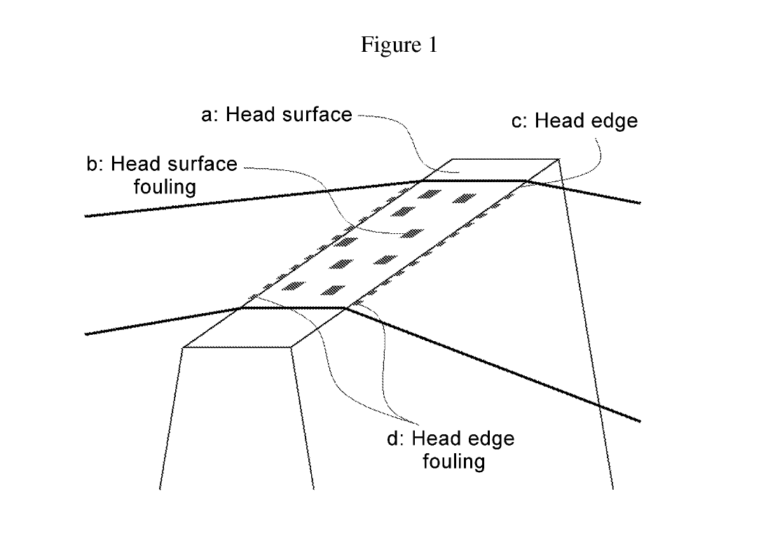

A surface treatment (in the form indicated in FIGS. 1 to 3 of Japanese Unexamined Patent Publication (KOKAI) Heisei No. 5-62174) was conducted with the diamond wheel described in Japanese Unexamined Patent Publication (KOKAI) Heisei No. 5-62174. The magnetic tape obtained was wound into a roll. Properties of the magnetic tape were then evaluated by the following evaluation methods.

In the present Example as well as in Examples and Comparative Examples set forth further below, the thickness of each layer is the design thickness calculated from the manufacturing conditions. The weight average molecular weight of the SO₃Na group-containing polyurethane resins mentioned above and further below is a value measured under the following measurement conditions.

GPC device: HLC-8120 (made by Tosoh Corp.)
Column: TSK get Multipore HXL-M (7.8 mm ID (inner diameter)×30.0 cm, made by Tosoh Corp.)

### Eluent: Tetrahydrofuran (THF)

<Evaluation Methods>

### (Contact Angle Measurement Method)

The contact angle was measured by the following method with a contact angle measuring device (Drop Master 700 contact angle measuring device made by Kyowa Interface Science (Ltd.)).

A tape sample, obtained by cutting a prescribed length from one end of a magnetic tape that had been wound into a roll, was placed on a slide glass such that the surface of the backcoat layer was in contact with the surface of the slide glass. A 2.0 μL quantity of measurement liquid (1-bromonaphthalene or water) was dripped onto the surface of the tape sample (surface of the magnetic layer). The fact that the liquid that was dripped formed a stable droplet was visually confirmed, after which the droplet image was analyzed by contact angle analysis software FAMAS that came with the above contact angle measuring device and the contact angle of the tape sample and the droplet was measured. The contact angle was calculated by the θ/2 method. The average of 6 measurements taken for each sample was adopted as the contact angle. The measurement was conducted in an environment of a temperature of 20° C. and 25% relative humidity. The contact angles were obtained under the following analysis conditions.

For reference, methylene iodide was employed as the measurement liquid and the same method was used to obtain the contact angle of methylene iodide (methylene iodide contact angle) of the magnetic layer surface.

Method: Liquid drop method (θ/2 method)

Recognition of liquid attachment: automatic

Liquid attachment recognition line (distance from top of needle): 50 dot

Algorithm: automatic

Image mode: frame

Threshold level: automatic

(Running Durability Test)

A magnetic recording and reproducing head removed from an LTO (Japanese registered trademark) G5 (Linear Tape-Open Generation 5) made by IBM Corp. was mounted in a tape running system under conditions of a temperature of 40° C. and 80% relative humidity. While applying 0.6 N of tension, a magnetic tape 20 m in length was caused to run 3,000 cycles at 4.0 m/s while being fed from a feed roll and picked up on a pickup roll. Following running, the entire surface of the head was observed under a microscope at 100-fold magnification. The area of fouling (the area of the portions where fouling had adhered) was determined by image processing using image processing software (WinRoof (made by Mitani Corporation)). The ratio of the area of fouling on the head surface was adopted as an index of head surface fouling and evaluated on the following scale. A running durability of A or B was determined to be good.

A: 0%, B: more than 0% but less than 5%, C: 5% or more but less than 10%, D: 10% or more but less than 30%, and E: 30% or more.

Further, head edge fouling was similarly evaluated by observing the entire surface of the head by microscope and image processing with image software. The ratio of the scope of adhesion of head edge fouling (deposits) was adopted as an index of head edge fouling and evaluated on the following scale. A score of 4 to 2 was considered good running durability. The width direction of the head was the direction that corresponded to the width direction of the magnetic tape.

4. No fouling of the head edge observed; 3: fouling observed on 50% or less in the width direction of the head; 2: more than 50% but 70% or less fouling observed in the width direction of the head; 1: fouling observed on more than 70% in the width direction of the head.

FIG. 1 shows a descriptive drawing of head surface fouling and head edge fouling. In the figure, solid line 2 indicates the edge in the longitudinal direction of the magnetic tape. In the figure, the number, shape, and adhesion position of head surface fouling and head edge fouling are mere schematic depictions.

(Centerline Average Surface Roughness Ra Measured by Atomic Force Microscope (AFM) on Surface of Magnetic Layer)

Employing a Nanoscope III made by Digital Instruments Corp. in contact made as an atomic force microscope, the centerline average surface roughness Ra of the magnetic layer surface was measured by the method set forth above. Specifically, following AFM measurement, a switch was made to offline mode, and flatten processing was conducted in the y direction and plane fit processing was conducted in the x direction to compensate for distortion, after which roughness processing was conducted and the Ra was calculated.

### Example 2

With the exception that the quantity of stearic acid was changed to 2.0 parts among the lubricants of the composition for forming the magnetic layer in Example 1, a magnetic tape was obtained by the same method as in Example 1.

### Example 3

With the exception that the quantity of stearic acid was changed to 4.0 parts among the lubricants of the composition for forming the magnetic layer in Example 1, a magnetic tape was obtained by the same method as in Example 1.

### Example 4

With the exceptions that the quantity of stearic acid was changed to 2.0 parts among the lubricants of the composition for forming the magnetic layer in Example 1 and the composition A for forming the backcoat layer was replaced with composition B below for forming the backcoat layer, a magnetic tape was obtained by the same method as in Example 1.

### (Composition B for Forming Backcoat Layer)

| | | |
|---|---|---|
| Carbon black (DBP oil absorption capacity: 74 cm³/100 g): | 100.0 | parts |
| Nitrocellulose: | 27.0 | parts |
| Sulfonic acid (salt) group-containing polyester polyurethane | 62.0 | parts |
| resin: | | |
| Polyester resin: | 4.0 | parts |
| Alumina powder (with specific surface area S_{BET}: 17 m²/g): | 0.6 | parts |
| Methyl ethyl ketone: | 600.0 | parts |
| Toluene: | 600.0 | parts |
| Stearic acid: | 4.0 | parts |
| Polyisocyanate (Coronate L, made by Nippon Polyurethane | 15.0 | parts |
| Industry Co., Ltd.) | | |

### Example 5

With the exception of changes (1) to (5) below, magnetic tapes were fabricated by the same method as in Example 2.

(1) With the exception that the magnetic liquid of the composition for forming the magnetic layer in Example 2 was changed as indicated to the following magnetic liquid, the composition for forming the magnetic layer was prepared by the same method as in Example 2.

### (Magnetic Liquid)

| | | |
|---|---|---|
| Ferromagnetic powder (ferromagnetic hexagonal barium | 100.0 | parts |
| ferrite powder B): (Hc: 189 kA/m (2,380 Oe), average | | |
| particle size (average plate diameter) 22 nm) | | |
| Oleic acid: | 2.0 | parts |
| Vinyl chloride copolymer (MR-104, Zeon Corp.): | 10.0 | parts |
| SO₃Na group-containing polyurethane resin: | 4.0 | parts |
| (weight average molecular weight: 60,000; SO₃Na groups: | | |
| 0.06 meq/g) | | |
| 1-Bromonaphthalene contact angel adjusting agent A: | 10.0 | parts |
| Methyl ethyl ketone: | 150.0 | parts |
| Cyclohexanone: | 150.0 | parts |

(3) The nonmagnetic support was changed to a polyethylene naphthalate support 6.00 μm in thickness.

(4) Lubricant overcoat processing was conducted by the method indicated below on the surface of the backcoat layer.

A coil bar on which a φ 50 μm coil had been wound was used to coat the following lubricant solution onto the surface of the backcoat layer. A heat treatment was applied for 12 hours in a 70° C. environment.

### (Lubricant Solution for Overcoat Treatment of Backcoat Layer)

| | | |
|---|---|---|
| Stearic acid: | 0.6 | parts |
| Amide stearate: | 0.2 | part |
| Methyl ethyl ketone: | 150.0 | parts |
| Cyclohexanone: | 150.0 | parts |

### Example 6

With the exception that the magnetic liquid of the composition for forming the magnetic layer in Example 5 was changed to the following magnetic liquid, a magnetic tape was fabricated by the same method as in Example 5.

### (Magnetic Liquid)

| | | |
|---|---|---|
| Ferromagnetic powder (ferromagnetic hexagonal barium | 100.0 | parts |
| ferrite powder B): (Hc: 189 kA/m (2,380 Oe), average | | |
| particle size (average plate diameter) 22 nm) | | |
| Oleic acid: | 2.0 | parts |
| Vinyl chloride copolymer (MR-104, Zeon Corp.): | 10.0 | parts |
| SO₃Na group-containing polyurethane resin: | 4.0 | parts |
| (weight average molecular weight: 50,000; SO₃Na groups: | | |
| 0.07 meq/g) | | |
| 1-Bromonaphthalene contact angle adjusting agent B: | 6.0 | parts |
| Methyl ethyl ketone: | 150.0 | parts |
| Cyclohexanone: | 150.0 | parts |

### Comparative Example 1

With the exceptions of changes (1) and (2) below, a magnetic tape was fabricated by the same method as in Example 2.

(1) The magnetic liquid of the composition for forming the magnetic layer in Example 1 was changed to the following magnetic liquid.

### (Magnetic Liquid)

| | | |
|---|---|---|
| Ferromagnetic powder (ferromagnetic hexagonal barium | 100.0 | parts |
| ferrite powder A): (Hc: 196 kA/m (2,460 Oe), average | | |
| particle size (average plate diameter) 24 nm) | | |
| Oleic acid: | 2.0 | parts |
| Vinyl chloride copolymer (MR-104, Zeon Corp.): | 13.0 | parts |
| SO₃Na group-containing polyurethane resin: | 5.0 | parts |
| (weight average molecular weight: 70,000; SO₃Na groups: | | |
| 0.07 meq/g) | | |
| Methyl ethyl ketone: | 150.0 | parts |
| Cyclohexanone: | 150.0 | parts |

(2) The quantity of stearic acid among the lubricants of the composition for forming the magnetic layer in Example 1 was changed to 2.0 parts.

### Comparative Example 2

With the exception that the quantity of stearic acid among the lubricants of the composition for forming the magnetic layer in Example 4 was changed to 6.0 parts, a magnetic tape was fabricated by the same method as in Example 4.

### Comparative Example 3

With the exception that no 1-bromonaphthylene contact angle adjusting agent A was added during preparation of the magnetic liquid of the composition for forming the magnetic layer in Example 6, a magnetic tape was fabricated by the same method as in Example 6.

### Comparative Example 4

With the exception that the magnetic liquid of the composition for forming the magnetic layer in Example 6 was changed to the following magnetic liquid, a magnetic tape was fabricated by the same method as in Example 6.

### (Magnetic Liquid)

| | | |
|---|---|---|
| Ferromagnetic powder (ferromagnetic hexagonal barium | 100.0 | parts |
| ferrite powder B): (Hc: 189 kA/m (2,380 Oe), average | | |
| particle size (average plate diameter) 22 nm) | | |
| Oleic acid: | 2.0 | parts |
| Vinyl chloride copolymer (MR-104, Zeon Corp.): | 10.0 | parts |
| SO₃Na group-containing polyurethane resin: | 4.0 | parts |
| (weight average molecular weight: 50,000; SO₃Na groups: | | |
| 0.07 meq/g) | | |
| 2,3-Dihydroxynaphthalene: | 6.0 | parts |
| Methyl ethyl ketone: | 150.0 | parts |
| Cyclohexanone: | 150.0 | parts |

The magnetic tapes fabricated in Examples 2 to 6 and Comparative Examples 1 to 4 were evaluated by the same methods as in Example 1.

The results are given in Table 2.

TABLE 2

| | | | Nonmagnetic layer | Backcoat layer | |
|---|---|---|---|---|---|
| | Magnetic layer | | Composition for | | Composition for |
| | Contact angle adjusting agent (Ex.) | Quantity of steatic | forming | Quantity of steatic | forming |
| | Substitute additive (Comp. Ex.) | acid in magnetic | nonmagnetic | acid in backcoat | backcoat |
| | (parts) | layer (parts) | layer | layer (parts) | layer |
| Ex. 1 | Contact angle adjusting agent A (10.0) | 3.0 | A | 1.0 | A |
| Ex. 2 | Contact angle adjusting agent A (10.0) | 2.0 | A | 1.0 | A |
| Ex. 3 | Contact angle adjusting agent A (10.0) | 4.0 | A | 1.0 | A |
| Ex. 4 | Contact angle adjusting agent A (10.0) | 2.0 | A | 4.0 | B |
| Ex. 5 | Contact angle adjusting agent A (10.0) | 2.0 | B | 1.0 | A |
| | | | | (Overcoat | |
| | | | | processing was | |
| | | | | further conducted.) | |
| Ex. 6 | Contact angle adjusting agent B (6.0) | 2.0 | B | 1.0 | A |
| Comp. Ex. 1 | None | 2.0 | A | 1.0 | A |
| Comp. Ex. 2 | Contact angle adjusting agentA (10.0) | 2.0 | A | 6.0 | B |
| Comp. Ex. 3 | None | 2.0 | B | 1.0 | A |
| Comp. Ex. 4 | 2,3-dihydroxynaphthalene (6.0) | 2.0 | B | 1.0 | A |

Evaluation results

Running durability

| | | Contact angle/° | | | Head | Head |
|---|---|---|---|---|---|---|
| | AFM | | 1-bromo- | Methylene | surface | edge |
| | Ra/nm | Water | naphthalene | iodide | fouling | fouling |
| Ex. 1 | 2.3 | 97.4 | 47.9 | 58.4 | A | 4 |
| Ex. 2 | 2.3 | 96.2 | 45.3 | 56.0 | B | 4 |
| Ex. 3 | 2.2 | 99.1 | 51.1 | 60.1 | A | 2 |
| Ex. 4 | 2.5 | 98.8 | 49.3 | 60.7 | A | 3 |
| Ex. 5 | 2.2 | 99.0 | 50.4 | 60.1 | A | 4 |
| Ex. 6 | 2.5 | 96.2 | 47.7 | 58.1 | A | 4 |
| Comp. Ex. 1 | 2.0 | 97.6 | 41.8 | 53.8 | D | 4 |
| Comp. Ex. 2 | 2.5 | 101.9 | 53.7 | 61.9 | A | 1 |
| Comp. Ex. 3 | 2.2 | 97.8 | 40.6 | 56.6 | D | 4 |
| Comp. Ex. 4 | 2.4 | 96.3 | 36.2 | 51.6 | E | 4 |

Evaluation Results

The less head surface fouling there was following the repeated running conducted for evaluation in Examples and Comparative Examples, the more stable the sliding property between the surface of the magnetic layer and the head during running and the better the running durability (the more the occurrence of shaving of the surface of the magnetic layer was inhibited) that were indicated.

The less head edge fouling there was following repeated running conducted for evaluation in Examples and Comparative Examples, the lower the spacing loss due to lubricant and the fewer magnetic layer shavings adhering to the head from the surface of the magnetic layer that were indicated.

Based on the results given in Table 2, the magnetic tapes of Examples 1 to 6 were found to have little head surface fouling or head edge fouling following repeated running. The magnetic tapes of Examples 1 to 5 can inhibit spacing loss due to the adhesion of magnetic layer shaving and lubricant to the head, and the resulting drop in output, even after repeated running.

As indicated in Table 2, a good correlation was not seen between the methylene iodide contact angle described in Japanese Unexamined Patent Publication (KOKAI) Heisei No. 11-259849 and the evaluation results, while a good correlation was seen between the 1-bromonaphthalene contact angle and water contact angle and the evaluation results.

Based on the above results, it can be understood that it is possible to provide a magnetic recording medium exhibiting good running durability and in which a drop in output following repeated running is inhibited by specifying the surface state of the magnetic layer of the magnetic recording medium based on the 1-bromonaphthalene contact angle and water contact angle.

An aspect of the present invention is useful in the field of manufacturing magnetic recording media for data storage, such as data backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium, which comprises a nonmagnetic layer comprising nonmagnetic powder and binder on a nonmagnetic support and a magnetic layer comprising ferromagnetic powder and binder on the nonmagnetic layer, wherein
the magnetic layer comprises a lubricant and a 1-bromonaphthalene contact angle adjusting agent that is capable of adjusting a contact angle for 1-bromonaphthalene, the contact angle for 1-bromonaphthalene being measured on a surface of the magnetic layer; and
a contact angle measured on the surface of the magnetic layer ranges from 45.0° to 55.0° for 1-bromonaphthalene, and ranges from 90.0° to 100.0° for water.

2. The magnetic recording medium according to claim 1, wherein the 1-bromonaphthalene contact angle adjusting agent is a polymer.

3. The magnetic recording medium according to claim 2, wherein the 1-bromonaphthalene contact angle adjusting agent is a nitrogen-containing polymer.

4. The magnetic recording medium according to claim 3, wherein the 1-bromonaphthalene contact angle adjusting agent is a polyalkyleneimine polymer.

5. The magnetic recording medium according to claim 4, wherein the 1-bromonaphthalene contact angle adjusting agent is a polyalkyleneimine polymer containing one or more polyalkyleneimine chains and one or more polyester chains.

6. The magnetic recording medium according to claim 2, wherein the 1-bromonaphthalene contact angle adjusting agent is an amine polymer.

7. The magnetic recording medium according to claim 1, wherein the magnetic layer comprises one or more lubricants selected from the group consisting of fatty acids, fatty acid esters, and fatty acid amides.

8. The magnetic recording medium according to claim 2, wherein the magnetic layer comprises one or more lubricants selected from the group consisting of fatty acids, fatty acid esters, and fatty acid amides.

9. The magnetic recording medium according to claim 3, wherein the magnetic layer comprises one or more lubricants selected from the group consisting of fatty acids, fatty acid esters, and fatty acid amides.

10. The magnetic recording medium according to claim 4, wherein the magnetic layer comprises one or more lubricants selected from the group consisting of fatty acids, fatty acid esters, and fatty acid amides.

11. The magnetic recording medium according to claim 5, wherein the magnetic layer comprises one or more lubricants selected from the group consisting of fatty acids, fatty acid esters, and fatty acid amides.

12. The magnetic recording medium according to claim 6, wherein the magnetic layer comprises one or more lubricants selected from the group consisting of fatty acids, fatty acid esters, and fatty acid amides.

13. The magnetic recording medium according to claim 1, wherein a thickness of the nonmagnetic layer is less than or equal to 0.80 μm.

14. The magnetic recording medium according to claim 1, wherein the nonmagnetic layer comprises a lubricant.

15. The magnetic recording medium according to claim 14, wherein the nonmagnetic layer comprises one or more lubricants selected from the group consisting of fatty acids, fatty acid esters, and fatty acid amides.

16. The magnetic recording medium according to claim 1, wherein the magnetic layer comprises one or more fatty acids, one or more fatty acid esters, and one or more fatty acid amides.

17. The magnetic recording medium according to claim 1, wherein a centerline average surface roughness Ra as measured by an atomic force microscope on the surface of the magnetic layer is less than or equal to 3.0 nm.
